(19) United States
(12) Patent Application Publication
(10) Pub. No.: US 2013/0339444 A1
(43) Pub. Date: Dec. 19, 2013

(54) ELECTRONIC DATA EXCHANGE SYSTEM AND METHOD OF EXCHANGING ELECTRONIC DATA

(71) Applicant: WINTEK CORPORATION, Taichung City (TW)

(72) Inventors: Ming-Chuan Lin, Taichung City (TW); Wen-Hung Wang, Taichung City (TW); Hsuan-Kuang Chen, Taichung City (TW); Li-Sheng Lu, Taichung City (TW); Yuan-Siang Song, Taoyuan County (TW); Wen-Hsin Wang, Changhua County (TW)

(21) Appl. No.: 13/916,602

(22) Filed: Jun. 13, 2013

(30) Foreign Application Priority Data
Jun. 13, 2012 (TW) 101121090

(51) Int. Cl. H04L 29/06

(52) U.S. Cl. CPC H04L 29/06414
USPC 709/204

(57) ABSTRACT

Electronic data exchange system includes a transmitting portable electronic device and a server. The transmitting portable electronic device has an application program. A user of the transmitting portable electronic device utilizes the application program to generate an electronic data transmission control command. The server includes a data base. The data base stores an electronic data album of the user. When the server transmits electronic data of the user to at least one receiving portable electronic device, and transmits electronic data of at least one user of the at least one receiving portable electronic device to the transmitting portable electronic device according to the electronic data transmission control command, the server updates the electronic data album according to the electronic data of the at least one user.

### BACKGROUND OF THE INVENTION

1. Field of the Invention

The present invention relates to an electronic data exchange system and a method of exchanging electronic data, and particularly to an electronic data exchange system and a method of exchanging electronic data that can utilize a server to update, edit, and manage a user electronic data album to reduce the risk of loss of electronic data of other people.

2. Description of the Prior Art

In the prior art, when a user wants to utilize a portable electronic device to execute electronic data exchange with other people, the user utilizes a Bluetooth transmission module of the portable electronic device to execute the electronic data exchange with portable electronic devices (also have a Bluetooth transmission module) owned by other people, or the user utilizes the portable electronic device to execute the electronic data exchange with other people through e-mail.

After the user utilizes the portable electronic device to execute the electronic data exchange with other people through the Bluetooth transmission module or e-mail, electronic data of other people are stored in a memory of the portable electronic device. Then, the user needs to classify the electronic data of other people himself. However, when the user loses the portable electronic device, the user also loses the electronic data of other people stored in the memory of the portable electronic device. Therefore, in the prior art, the electronic data of other people stored in the memory of the portable electronic device may let the user be in the risk of loss of the electronic data of other people.

### SUMMARY OF THE INVENTION

An embodiment provides an electronic data exchange system. The electronic data exchange system includes a transmitting portable electronic device and a server. The transmitting portable electronic device has an electronic data exchange application program, where a user of the transmitting portable electronic device utilizes the electronic data exchange application program to generate an electronic data transmission control command. The server includes a data base, where the data base is used for storing an electronic data album of the user, where when the server transmits electronic data of the user to at least one receiving portable electronic device according to the electronic data transmission control command, and transmits electronic data of at least one user of the at least one receiving portable electronic device to the transmitting portable electronic device, the server updates the electronic data album of the user according to the electronic data of the at least one user. The at least one receiving portable electronic device has the electronic data exchange application program, and the electronic data album comprises the electronic data of the user and electronic data of other people.

Another embodiment provides a method of exchanging electronic data. The method includes a user turning on an electronic data exchange application program of a transmitting portable electronic device; generating an electronic data transmission control command through the electronic data exchange application program; exchanging electronic data of the user and electronic data of at least one user of at least one receiving portable electronic device according to the electronic data transmission control command; and updating an electronic data album of the user stored in a data base according to the electronic data of the at least one user. The at least one receiving portable electronic device has the electronic data exchange application program.

Another embodiment provides a transmitting portable electronic device. The transmitting portable electronic device includes a electronic data exchange application program, where a user utilizes the electronic data exchange application program to generate an electronic data transmission control command to a server or at least one receiving portable electronic device, wherein the at least one receiving portable electronic device has the electronic data exchange application program. The server or the at least one receiving portable electronic device executes a corresponding operation according to the electronic data transmission control command.

The present invention provides an electronic data exchange system and a method of exchanging electronic data. The electronic data exchange system and the method utilize an electronic data exchange application program included in a transmitting portable electronic device to generate an electronic data transmission control command. Then, after a server receives the electronic data transmission control command, the server transmits electronic data of a user of the portable electronic device to at least one receiving portable electronic device, and transmits electronic data of at least one user of the at least one receiving portable electronic device to the transmitting portable electronic device according to a combination of a location and a direction of the transmitting portable electronic device, or a group which the transmitting portable electronic device belongs to, or the transmitting portable electronic device transmits the electronic data of the user of the transmitting portable electronic device to the at least one receiving portable electronic device through Wireless Fidelity, Bluetooth, or Worldwide Interoperability for Microwave Access, and the at least one receiving portable electronic device transmits the electronic data of the at least one user of the at least one receiving portable electronic device to the transmitting portable electronic device through the Wireless Fidelity, the Bluetooth, or the Worldwide Interoperability for Microwave Access. Finally, when the transmitting portable electronic device communicates with the server, the server can update the electronic data album of the user stored in the server according to the electronic data of the at least one user of the at least one receiving portable electronic device received by the transmitting portable electronic device. Therefore, the server provided by the present invention can let the user of the transmitting portable electronic device update, edit, and manage the electronic data album of the user to reduce risk of the user of the transmitting portable electronic device losing electronic data of other people.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic data exchange system according to an embodiment.

FIG. 2 is a diagram illustrating coordinate axes of the portable electronic device.

FIG. 3 is a diagram illustrating the server executing another electronic data exchange according to the location and the direction of the portable electronic device.

FIG. 4 is a diagram illustrating the server executing another electronic data exchange according to a group which the portable electronic device belongs to.

FIG. 5 is a diagram illustrating the portable electronic device directly communicating with the portable electronic devices.

FIG. 6 and FIG. 7 are diagrams illustrating the user utilizing the portable electronic device to generate the electronic data exchange after the user turns on the electronic data exchange application program.

FIG. 8 is a flowchart illustrating a method of exchanging electronic data according to another embodiment.

### DETAILED DESCRIPTION

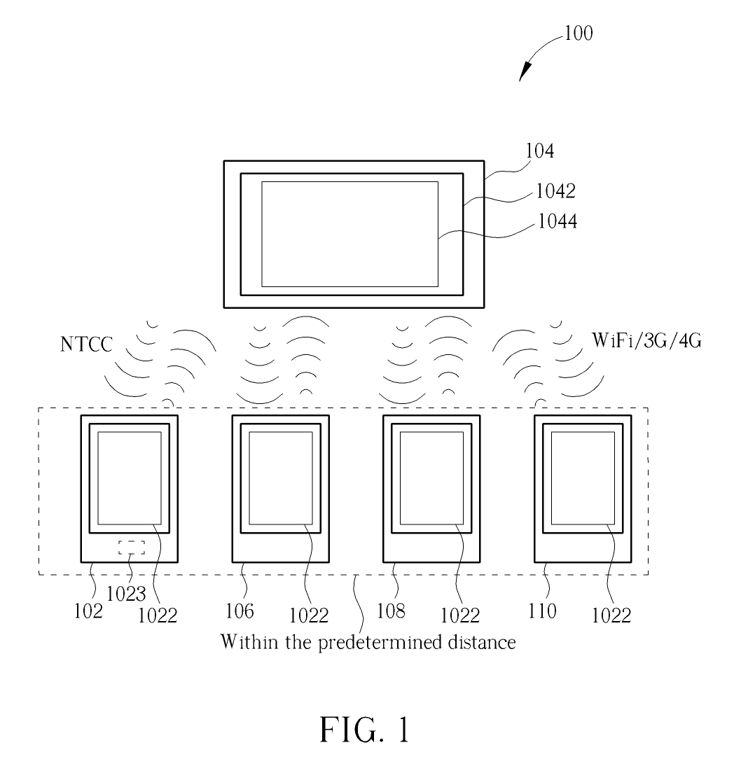

Please refer to FIG. 1. FIG. 1 is a diagram illustrating an electronic data exchange system 100 according to an embodiment. The electronic data exchange system 100 includes a portable electronic device 102 and a server 104, where the portable electronic device 102 can be a mobile phone, a tablet computer, or a personal digital assistant. The portable electronic device 102 has an electronic data exchange application program 1022, where a user of the portable electronic device 102 can utilize the electronic data exchange application program 1022 to generate an electronic data transmission control command NTCC. Meanwhile, the portable electronic device 102 acts as a transmitting portable electronic device, where the electronic data exchange application program 1022 can be an electronic data exchange application program which supports an Android system or an Apple system. But, the present invention is not limited to the electronic data exchange application program 1022 being an electronic data exchange application program which supports the Android system or the Apple system. The server 104 includes a data base 1042, where the data base 1042 is used for storing an electronic data album 1044 of the user, and the electronic data album 1044 includes electronic data of the user and electronic data of other people. In addition, the portable electronic device 102 communicates with the server 104 through Wireless Fidelity (Wi-Fi), third generation (3G), or fourth generation (4G). In addition, the user can utilize the portable electronic device 102 to log in the server 104 through a website of Internet to edit and manage the electronic data album 1044 stored in the data base 1042, where the electronic data can be name cards, pictures, texts, and so on. But, the present invention is not limited to the electronic data being name cards, pictures, texts, and so on. In addition, the user can edit and manage pictures, fonts, colors, patterns, layout formats and/or backgrounds of the electronic data on the portable electronic device 102 (e.g. a mobile phone) and a website.

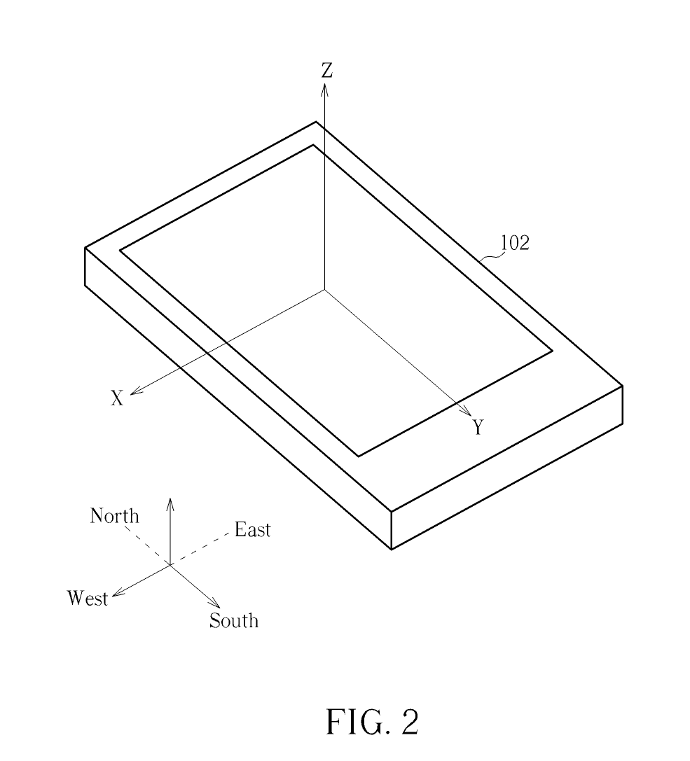

As shown in FIG. 1, the portable electronic device 102 further includes a sensor 1023 for detecting a location (e.g. latitude and longitude of the portable electronic device 102) and a direction of the portable electronic device 102. In addition, each of other portable electronic devices 106, 108, and 110 also includes a sensor (not shown in FIG. 1) for detecting a location and a direction thereof. Please refer to FIG. 1 and FIG. 2. FIG. 2 is a diagram illustrating coordinate axes of the portable electronic device 102. As shown in FIG. 1 and FIG. 2, the sensor 1023 can determine the direction of the portable electronic device 102 according to the coordinate axes of the portable electronic device 102. As shown in FIG. 1, after the server 104 receives the electronic data transmission control command NTCC within a predetermined time, the server 104 can transmit the electronic data of the user to the portable electronic devices 106, 108, and 110 (all having the electronic data exchange application program 1022) according to the location of the portable electronic device 102. Meanwhile, the portable electronic devices 106, 108, and 110 all act as receiving portable electronic devices, where the portable electronic devices 106, 108, and 110 are located within a predetermined distance from the location of the portable electronic device 102, and the predetermined distance is a default value of the electronic data exchange application program 1022. In addition, the server 104 can also transmit electronic data of users of the portable electronic devices 106, 108, and 110 to the portable electronic device 102. Meanwhile, the portable electronic devices 106, 108, and 110 all act as transmitting portable electronic devices, and the portable electronic device 102 acts as a receiving portable electronic device. But, the present invention is not limited to three portable electronic devices 106, 108, and 110. That is to say, any portable electronic device (having the electronic data exchange application program, and an electronic data exchange application program thereof is turned on) located within the predetermined distance from the location of the portable electronic device 102 can execute electronic data exchange with the portable electronic device 102 through the server 104. But, in another embodiment of the present invention, the user can set the predetermined distance through the electronic data exchange application program 1022. For example, the user can set the predetermined distance as 100 meters through the electronic data exchange application program 1022. Therefore, any portable electronic device (having the electronic data exchange application program, and the electronic data exchange application program thereof is turned on) located within 100 meters from the location of the portable electronic device 102 can execute the electronic data exchange with the portable electronic device 102 through the server 104. In addition, the server 104 can update the electronic data album 1044 of the user according to the electronic data of the users of the portable electronic devices 106, 108, and 110. But, in another embodiment of the present invention, after the server 104 receives the electronic data transmission control command NTCC, the server 104 immediately transmits the electronic data of the user to the portable electronic devices 106, 108, and 110, and transmits the electronic data of the users of the portable electronic devices 106, 108, and 110 to the portable electronic device 102 according to the location of the portable electronic device 102. In addition, in another embodiment in FIG. 1, when an electronic data exchange password of the portable electronic device 102 is the same as electronic data exchange passwords of the portable electronic devices 106 and 108, and is different from an electronic data exchange password of the portable electronic device 110, the server 104 only transmits the electronic data of the user to the portable electronic devices 106 and 108, and transmits the electronic data of the users of the portable electronic devices 106 and 108 to the portable electronic device 102. That is to say, the user of the portable electronic device 102 can not execute the electronic data exchange with the user of the portable electronic device 110 through the server 104.

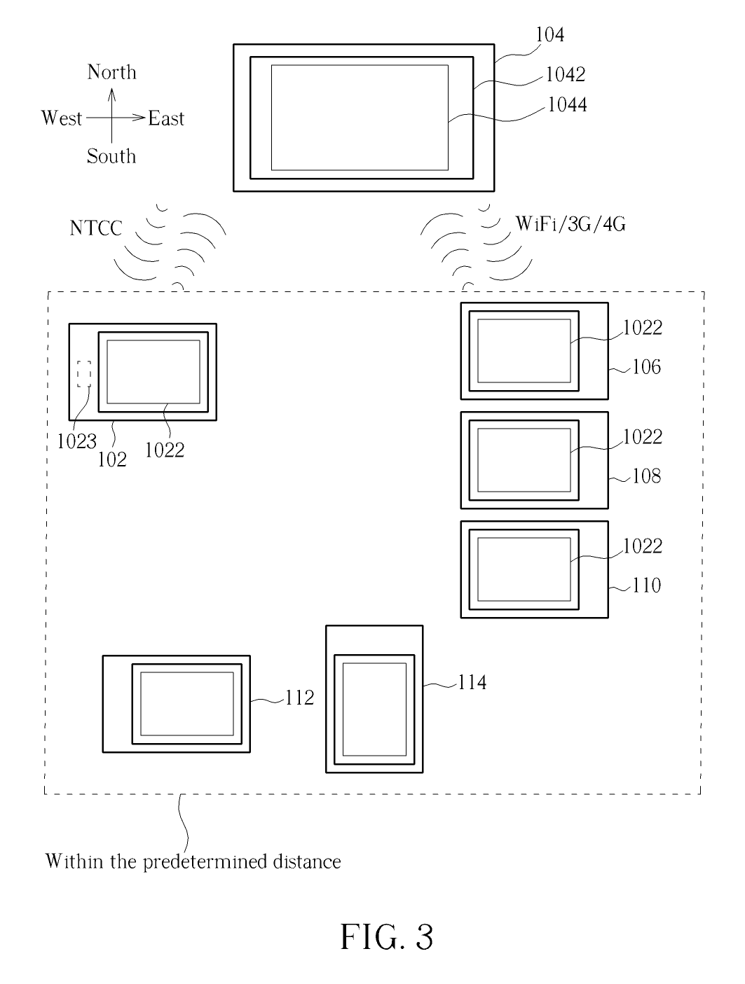

Please refer to FIG. 3. FIG. 3 is a diagram illustrating the server 104 executing another electronic data exchange according to the location and the direction of the portable electronic device 102. As shown in FIG. 3, after the server 104 receives the electronic data transmission control command NTCC transmitted by the portable electronic device 102 within a predetermined time, the server 104 calculates a location and a direction of each of portable electronic devices 102, 106, 108, 110, 112, and 114 according to an electronic compass or the sensor 1023 to determine that the portable electronic device 102 can not communicate with the portable electronic devices 112 and 114, and the portable electronic device 102 can communicate with the portable electronic devices 106, 108, and 110. That is to say, because the portable electronic device 102 is toward the east, the portable electronic device 112 is toward the east, and the portable electronic device 114 is toward the south, the server 104 determines that the portable electronic device 102 can not communicate with the portable electronic devices 112 and 114. In addition, because the portable electronic device 102 is toward the east, and the portable electronic devices 106, 108, and 110 are toward the west (that is, the portable electronic devices 106, 108, and 110 face the portable electronic device 102), the server 104 determines that the portable electronic device 102 can communicate with the portable electronic devices 106, 108, and 110. But, the present invention is not limited to the above mentioned electronic data exchange method executed by the server 104 according to the location and the direction of the portable electronic device 102. Therefore, as shown in FIG. 3, after the server 104 receives the electronic data transmission control command NTCC within the predetermined time, the server 104 can transmit the electronic data of the user to the portable electronic devices 106, 108, and 110, and transmit the electronic data of the users of the portable electronic devices 106, 108, and 110 to the portable electronic device 102 according to the location and the direction of the portable electronic device 102. In addition, subsequent operational principles of the embodiment in FIG. 3 are the same as those of the embodiment in FIG. 1, so further description thereof is omitted for simplicity.

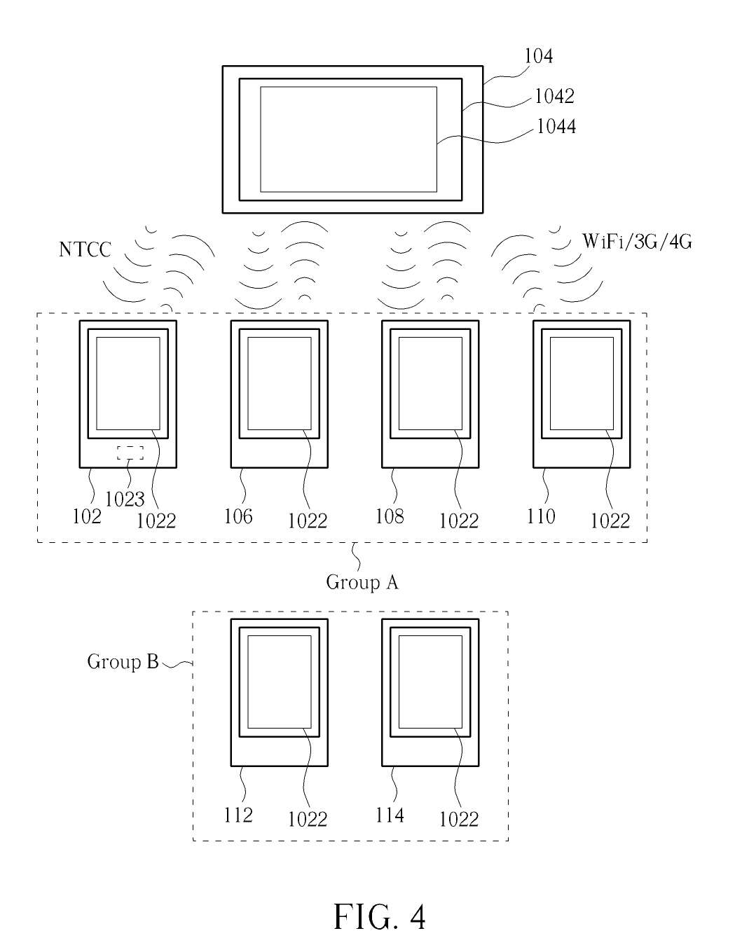

Please refer to FIG. 4. FIG. 4 is a diagram illustrating the server 104 executing another electronic data exchange according to a group which the portable electronic device 102 belongs to. As shown in FIG. 4, after the server 104 receives an electronic data transmission control command NTCC transmitted by the portable electronic device 102 within the predetermined time, the server 104 can execute electronic data exchange according to the group which the portable electronic device belongs to. As shown in FIG. 4, the portable electronic devices 106, 108, and 110, and the portable electronic device 102 belong to a group A, but the portable electronic devices 112 and 114 belong to a group B. Therefore, the server 104 only transmits the electronic data of the user to the portable electronic devices 106, 108, and 110, and transmits the electronic data of the users of the portable electronic devices 106, 108, and 110 to the portable electronic device 102 according to the group (the group A) which the portable electronic device 102 belongs to. That is to say, the portable electronic devices 106, 108, and 110 do not need to be located within the predetermined distance from the location of the portable electronic device 102 to execute the electronic data exchange with the portable electronic device 102 through the server 104. In addition, subsequent operational principles of the embodiment in FIG. 4 are the same as those of the embodiment in FIG. 1, so further description thereof is omitted for simplicity.

In addition, in another embodiment of the present invention, the server 104 executes the electronic data exchange according to the group which the portable electronic device 102 belongs to and the location of the portable electronic device 102. In addition, in another embodiment of the present invention, the server 104 executes the electronic data exchange according to the group which the portable electronic device 102 belongs to, and the location and the direction of the portable electronic device 102.

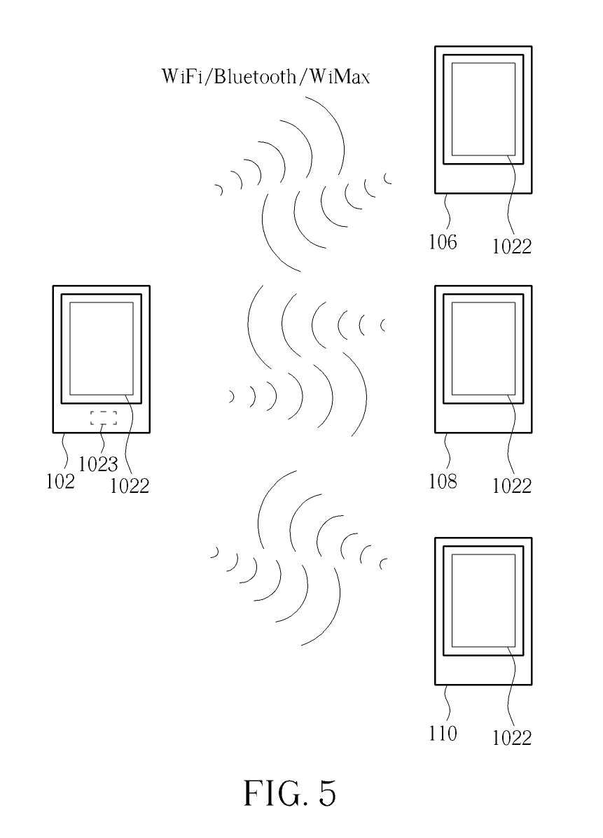

Please refer to FIG. 5. FIG. 5 is a diagram illustrating the portable electronic device 102 directly communicating with the portable electronic devices 106, 108, and 110. As shown in FIG. 5, when the portable electronic devices 106, 108, and 110 are located within the predetermined distance from the location of the portable electronic device 102, or the portable electronic devices 106, 108, and 110, and the portable electronic device 102 belong to the same group, and the portable electronic devices 106, 108, and 110, and the portable electronic device 102 cannot communicate with the server 104 (that is, poor communication), the portable electronic device 102 can directly transmit the electronic data of the user to the portable electronic devices 106, 108, and 110, and the portable electronic devices 106, 108, and 110 can directly transmit the electronic data of the users of the portable electronic devices 106, 108, and 110 to the portable electronic device 102. That is to say, the portable electronic device 102 can transmit the electronic data of the user to the portable electronic devices 106, 108, and 110 through the Wireless Fidelity, the Bluetooth, or the Worldwide Interoperability for Microwave Access (Wimax), and the portable electronic devices 106, 108, and 110 can also transmit the electronic data of the users of the portable electronic devices 106, 108, and 110 to the portable electronic device 102 through the Wireless Fidelity, the Bluetooth, or the Worldwide Interoperability for Microwave Access (Wimax). When the portable electronic device 102 communicates with the server 104 again, the server 104 can update the electronic data album 1044 of the user according to the electronic data of the users of the portable electronic devices 106, 108, and 110 received by the portable electronic device 102. But, in another embodiment of the present invention, the user manually turns off communication between the portable electronic device 102 and the server 104. After the portable electronic device 102 receives the electronic data of the users of the portable electronic devices 106, 108, and 110, the user selects an appropriate time point to turn on the communication between the portable electronic device 102 and the server 104 again.

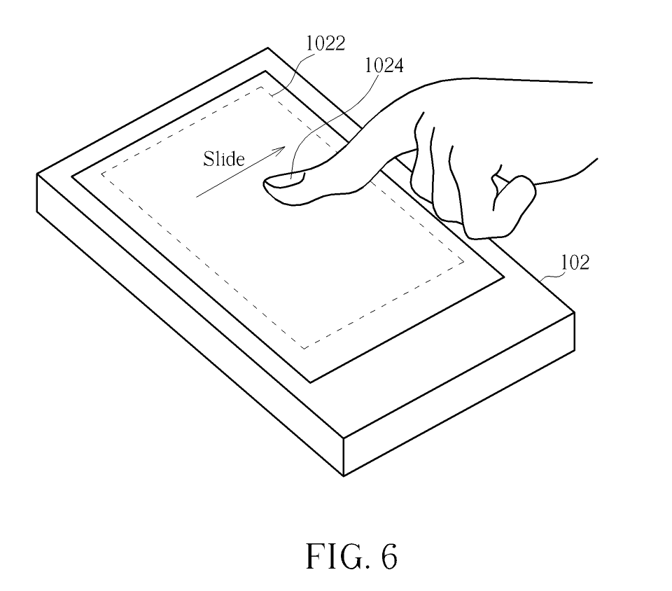

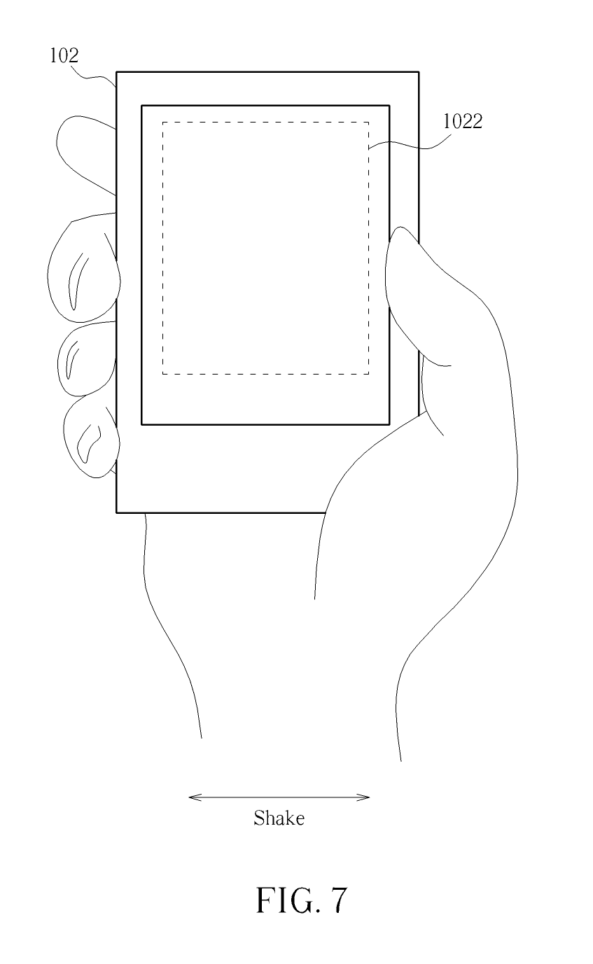

Please refer to FIG. 6 and FIG. 7. FIG. 6 and FIG. 7 are diagrams illustrating the user utilizing the portable electronic device 102 to generate the electronic data exchange after the user turns on the electronic data exchange application program 1022. As shown in FIG. 6, the user utilizes a finger 1024 to slide on the electronic data exchange application program 1022 to generate the electronic data transmission control command NTCC; and as shown in FIG. 7, after the user turns on the electronic data exchange application program 1022, the user shakes the portable electronic device 102 to generate the electronic data transmission control command NTCC.

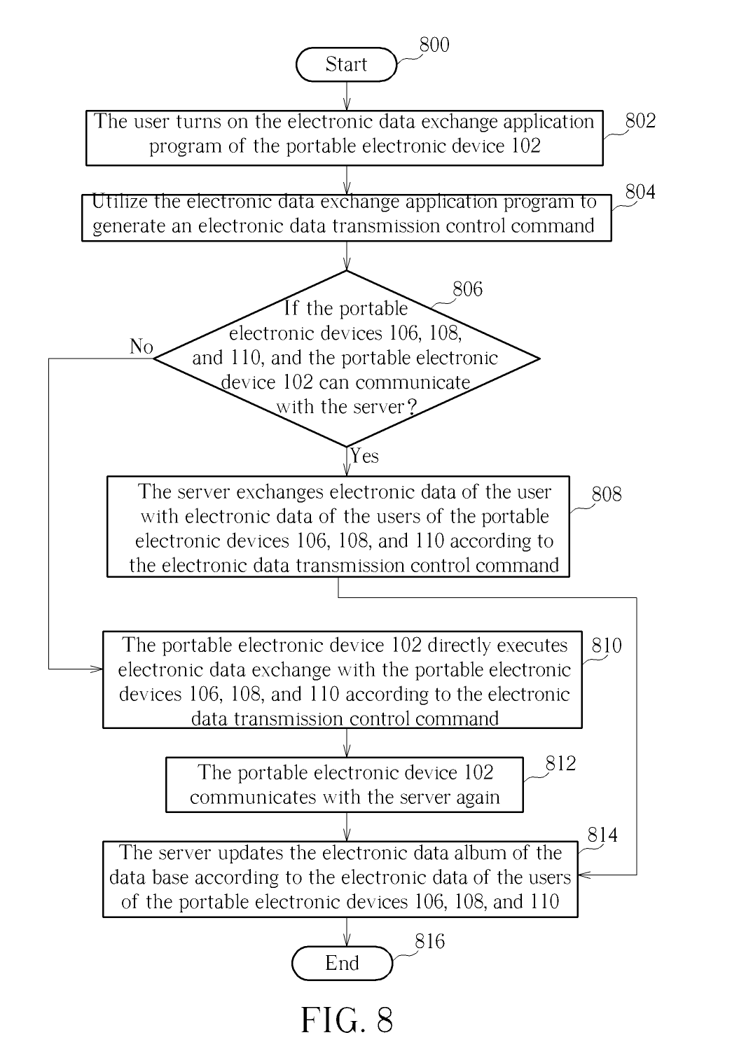

Please refer to FIG. 1 to FIG. 8. FIG. 8 is a flowchart illustrating a method of exchanging electronic data according to another embodiment. The method in FIG. 8 is illustrated using the electronic data exchange system 100 in FIG. 1. Detailed steps are as follows:

Step 800: Start.

Step 802: The user turns on the electronic data exchange application program 1022 of the portable electronic device 102.

Step 804: Utilize the electronic data exchange application program 1022 to generate an electronic data transmission control command NTCC.

Step 806:If the portable electronic devices 106, 108, and 110, and the portable electronic device 102 can communicate with the server 104? If yes, go to Step 808, if no, go to Step 810.

Step 808: The server 104 exchanges electronic data of the user with electronic data of the users of the portable electronic devices 106, 108, and 110 according to the electronic data transmission control command NTCC; go to Step 814.

Step 810: The portable electronic device 102 directly executes electronic data exchange with the portable electronic devices 106, 108, and 110 according to the electronic data transmission control command NTCC.

Step 812: The portable electronic device 102 communicates with the server 104 again.

Step 814: The server 104 updates the electronic data album 1044 of the data base 1042 according to the electronic data of the users of the portable electronic devices 106, 108, and 110.

Step 816: End.

In Step 804, the user utilizes the finger 1024 to slide on the electronic data exchange application program 1022 (as shown in FIG. 6) to generate the electronic data transmission control command NTCC, or after the user turns on the electronic data exchange application program 1022, the user shakes the portable electronic device 102 (as shown in FIG. 7) to generate the electronic data transmission control command NTCC. In Step 808, the server 104 transmits the electronic data of the user to the portable electronic devices 106, 108, and 110, and transmits the electronic data of the users of the portable electronic devices 106, 108, and 110 to the portable electronic device 102 according to the location of the portable electronic device 102 (as shown in FIG. 1), the combination of the location and the direction of the portable electronic device 102 (as shown in FIG. 3), or the group which the portable electronic device 102 belongs to (as shown in FIG. 4) after the server 104 receives the electronic data transmission control command NTCC within the predetermined time, where the sensor 1023 included in the portable electronic device 102 can detect the location of the portable electronic device 102 (e.g. the latitude and the longitude of the portable electronic device 102), and the direction of the portable electronic device 102, and the portable electronic device 102 communicates with the server 104 through Wireless Fidelity (Wi-Fi), third generation (3G), or fourth generation (4G). But, in another embodiment of the present invention, after the server 104 receives the electronic data transmission control command NTCC, the server 104 immediately transmits the electronic data of the user to the portable electronic devices 106, 108, and 110, and transmits the electronic data of the users of the portable electronic devices 106, 108, and 110 to the portable electronic device 102 according to the combination of the location and the direction of the portable electronic device 102, or the group which the portable electronic device 102 belongs to. In addition, in another embodiment in FIG. 1, FIG. 3, and FIG. 4, when the electronic data exchange password of the portable electronic device 102 is the same as the electronic data exchange passwords of the portable electronic devices 106 and 108, and is different from the electronic data exchange password of the portable electronic device 110, the server 104 only transmits the electronic data of the user to the portable electronic devices 106 and 108, and transmits the electronic data of the users of the portable electronic devices 106 and 108 to the portable electronic device 102. That is to say, the portable electronic device 102 can not execute the electronic data exchange with the portable electronic device 110 through the server 104. In Step 810, when the portable electronic devices 106, 108, and 110 are located within the predetermined distance from the location of the portable electronic device 102, and the portable electronic devices 106, 108, and 110, and the portable electronic device 102 can not communicate with the server 104 (the poor communication), the portable electronic device 102 can transmit the electronic data of the user to the portable electronic devices 106, 108, and 110 through the Wireless Fidelity, the Bluetooth, or the Worldwide Interoperability for Microwave Access (Wimax), and the portable electronic devices 106, 108, and 110 can also transmit the electronic data of the users of the portable electronic devices 106, 108, and 110 to the portable electronic device 102 through the Wireless Fidelity, the Bluetooth, or the Worldwide Interoperability for Microwave Access (Wimax). But, in another embodiment of the present invention, the user manually turns off communication between the portable electronic device 102 and the server 104. In Step 812, the user can select an appropriate time point to turn on the communication between the portable electronic device 102 and the server 104 again, or the portable electronic device 102 is placed on a good communication location to communicate with the server 104 again.

To sum up, the electronic data exchange system and the method of exchanging electronic data utilize the electronic data exchange application program included in the portable electronic device to generate an electronic data transmission control command. Then, after the server receives the electronic data transmission control command, the server transmits electronic data of the user of the portable electronic device to other portable electronic devices, and transmits electronic data of at least one user of other portable electronic devices to the portable electronic device according to the a combination of a location and a direction of the portable electronic device, or a group which the portable electronic device belongs to, or the portable electronic device transmits the electronic data of the user of the portable electronic device to other portable electronic devices through the Wireless Fidelity, the Bluetooth, or the Worldwide Interoperability for Microwave Access, and other portable electronic devices transmits the electronic data of the at least one user of the other portable electronic devices to the portable electronic device through the Wireless Fidelity, the Bluetooth, or the Worldwide Interoperability for Microwave Access. Finally, when the portable electronic device communicates with the server, the server can update the electronic data album of the user stored in the server according to the electronic data of the at least one user of other portable electronic devices received by the portable electronic device. Therefore, the server provided by the present invention can let the user of the portable electronic device update, edit, and manage the electronic data album of the user to reduce risk of the user of the portable electronic device losing electronic data of other people.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic data exchange system, comprising:
a transmitting portable electronic device having an electronic data exchange application program, wherein a user of the transmitting portable electronic device utilizes the electronic data exchange application program to generate an electronic data transmission control command; and
a server comprising a data base, wherein the data base is used for storing an electronic data album of the user, wherein when the server transmits electronic data of the user to at least one receiving portable electronic device according to the electronic data transmission control command, and transmits electronic data of at least one user of the at least one receiving portable electronic device to the transmitting portable electronic device, the server updates the electronic data album of the user according to the electronic data of the at least one user;
wherein the at least one receiving portable electronic device has the electronic data exchange application program, and the electronic data album comprises the electronic data of the user and electronic data of other people.

2. The electronic data exchange system of claim 1, wherein the transmitting portable electronic device further comprises:
a sensor for detecting a location and a direction of the transmitting portable electronic device.

3. The electronic data exchange system of claim 2, wherein the at least one receiving portable electronic device is located within a predetermined distance from the location of the transmitting portable electronic device, wherein the predetermined distance is a default value of the electronic data exchange application program.

4. The electronic data exchange system of claim 2, wherein the server transmits the electronic data of the user to the at least one receiving portable electronic device, and transmits the electronic data of the at least one user of the at least one receiving portable electronic device to the transmitting portable electronic device according to a combination of the location and the direction of the transmitting portable electronic device, or a group which the transmitting portable electronic device belongs to.

5. The electronic data exchange system of claim 4, wherein the server transmits the electronic data of the user to the at least one receiving portable electronic device, and transmits the electronic data of the at least one user of the at least one receiving portable electronic device to the transmitting portable electronic device after the server receives the electronic data transmission control command within a predetermined time.

6. The electronic data exchange system of claim 1, wherein the transmitting portable electronic device and the at least one receiving portable electronic device has the same electronic data exchange password.

7. The electronic data exchange system of claim 1, wherein the transmitting portable electronic device directly transmits the electronic data of the user to the at least one receiving portable electronic device, and the at least one receiving portable electronic device directly transmits the electronic data of the at least one user of the at least one receiving portable electronic device to the transmitting portable electronic device when the at least one receiving portable electronic device is located within a predetermined distance from the location of the transmitting portable electronic device, and the at least one receiving portable electronic device and the transmitting portable electronic device do not communicate with the server.

8. The electronic data exchange system of claim 1, wherein the user utilizes at least one finger to slide on the electronic data exchange application program, or shakes the transmitting portable electronic device to generate the electronic data transmission control command after the user turns on the electronic data exchange application program.

9. A method of exchanging electronic data, the method comprising:
a user turning on an electronic data exchange application program of a transmitting portable electronic device;
generating an electronic data transmission control command through the electronic data exchange application program;
exchanging electronic data of the user and electronic data of at least one user of at least one receiving portable electronic device according to the electronic data transmission control command; and
updating an electronic data album of the user stored in a data base according to the electronic data of the at least one user;
wherein the at least one receiving portable electronic device has the electronic data exchange application program.

10. The method of claim 9, wherein exchanging the electronic data of the user and the electronic data of the at least one user of the at least one receiving portable electronic device according to the electronic data transmission control command comprises:
the transmitting portable electronic device directly transmitting the electronic data of the user to the at least one receiving portable electronic device, and the at least one receiving portable electronic device directly transmitting the electronic data of the at least one user of the at least one receiving portable electronic device to the transmitting portable electronic device when the at least one receiving portable electronic device is located within a predetermined distance from the transmitting portable electronic device, and the at least one receiving portable electronic device and the transmitting portable electronic device do not communicate with the server.

11. The method of claim 9, wherein exchanging the electronic data of the user and the electronic data of the at least one user of the at least one receiving portable electronic device according to the electronic data transmission control command comprises:
a server transmitting the electronic data of the user to the at least one receiving portable electronic device, and transmitting the electronic data of the at least one user of the at least one receiving portable electronic device to the transmitting portable electronic device according to a combination of a location and a direction of the transmitting portable electronic device, or a group which the transmitting portable electronic device belongs to.

12. The method of claim 11, wherein the location and the direction of the transmitting portable electronic device is detected by a sensor comprised in the transmitting portable electronic device.

13. A transmitting portable electronic device, comprising:
an electronic data exchange application program, wherein a user utilizes the electronic data exchange application program to generate an electronic data transmission control command to a server or at least one receiving portable electronic device, wherein the at least one receiving portable electronic device has the electronic data exchange application program;
wherein the server or the at least one receiving portable electronic device executes a corresponding operation according to the electronic data transmission control command.

14. The transmitting portable electronic device of claim 13, wherein the server executing the corresponding operation according to the electronic data transmission control command is the server transmitting electronic data of the user to the at least one receiving portable electronic device, and transmitting electronic data of at least one user of the at least one receiving portable electronic device to the transmitting portable electronic device according to the electronic data transmission control command.

15. The transmitting portable electronic device of claim 13, wherein the at least one receiving portable electronic device executing the corresponding operation according to the electronic data transmission control command is the at least one receiving portable electronic device directly transmitting the electronic data of the at least one user of the at least one receiving portable electronic device to the transmitting portable electronic device.
